(19) United States
(12) Patent Application Publication
(10) Pub. No.: US 2005/0065694 A1
(43) Pub. Date: Mar. 24, 2005

(54) Method and device for considering the driver's steering response in stabilizing a vehicle-trailer combination

(76) Inventor: Gero Nenninger, Markgroeningen (DE)

Correspondence Address: KENYON & KENYON, ONE BROADWAY, NEW YORK, NY, 10004, US

(21) Appl. No.: 10/917,197

(22) Filed: Aug. 12, 2004

(30) Foreign Application Priority Data
Feb. 2, 2004 (DE) 10 2004 005 074.0
Sep. 18, 2003 (DE) 103 43 186.1

(51) Int. Cl. G06F 17/00

(52) U.S. Cl. 701/70

(57) ABSTRACT

A device for damping the snaking motion of a trailer towed by a road vehicle is described, including snaking motion detection means by which the trailer's snaking motion and the motion's intensity are detected based on a variable into which there enters at least one variable describing the transverse vehicle dynamics, and snaking damping means which, when an intensity limiting value is exceeded by the intensity of the snaking motion, damp the snaking motion on the basis of driver-independent braking interventions in the road vehicle and/or a driver-independent throttling of the engine torque. The main object is characterized in that steering angle analyzing means are present which determine at least one parameter from the shape of the curve over time of the steering angle, and the intensity limiting value, in response to whose exceeding by the intensity of the snaking motion, the snaking motion is damped, is a function of the parameter determined.

### BACKGROUND OF THE INVENTION

1. Field of the Invention

The present invention is directed to a method and a device for stabilizing a road vehicle according to German Patent No. 199 64 048.

2. Description of Related Art

German Patent No. 199 64 048 describes monitoring of a road vehicle, in particular a passenger car and a trailer towed by the passenger car, with regard to snaking motions. A yaw moment, which is essentially in phase opposition with the snaking motion, is automatically impressed on the vehicle when a snaking motion is detected.

The features of the definitions of the species of the independent claims are those of German Patent No. 199 64 048.

### SUMMARY OF THE INVENTION

The present invention relates to a device for damping the snaking motion of a trailer towed by a road vehicle, including
snaking motion detection means using which the trailer's snaking motion and its intensity are detected based on a variable into which there enters at least one variable describing the transverse vehicle dynamics, and
snaking damping means which, when an intensity limiting value is exceeded due to the intensity of the snaking motion, damp the snaking motion on the basis of driver-independent braking interventions in the road vehicle and/or a driver-independent throttling of the engine torque.

The core of the present invention is characterized in that
steering angle analyzing means are present which determine at least one parameter from the shape of the curve of the steering angle over time, and
the intensity limiting value, in response to whose exceeding by the intensity of the snaking motion, the snaking motion is damped, is a function of the parameter determined.

### BRIEF DESCRIPTION OF THE DRAWINGS The present invention will be described in greater detail with reference to the following drawings wherein:

FIG. 1 shows the configuration of the overall system.

FIG. 2 shows the analysis of the steering angle.

### DETAILED DESCRIPTION OF THE INVENTION

Since the variation of the steering angle represents the driver's intent, it is thus possible to adapt the damping of the snaking motion to the preceding driver behavior. The variable in particular, into which there enters the at least one variable describing the transverse vehicle dynamics, may be a combined variable, which is a function of the variable describing the transverse vehicle dynamics as well as a driver's intent variable.

An advantageous embodiment of the present invention is characterized in that the steering angle analyzing means are designed in such a way that, at least based on the parameter determined thereby, a distinction is made between
a present panic steering response by the driver, and
a driving maneuver deliberately carried out by the driver, and in that
the intensity limiting value is a function of whether a panic steering response by the driver or a driving maneuver carried out deliberately by the driver is present.

In particular during a driving maneuver, detected as being carried out deliberately, the experienced driver should have the possibility of stabilizing the vehicle-trailer combination using his/her driving skills (“driving pleasure”).

An advantageous embodiment of the present invention is characterized in that a panic steering response by the driver is determined to be present when the parameter determined exceeds a parameter threshold value.

An advantageous embodiment of the present invention is characterized in that the parameter threshold value is dependent on the vehicle's longitudinal speed. This makes it possible that, in the low-speed range, the driving skills may be utilized to a greater extent, while at high speeds a driver-independent stabilizing intervention is preferably used.

An advantageous embodiment of the present invention is characterized in that a panic steering response by the driver is only determined when the intensity of the snaking motion additionally increases over time, or when a vibration having a rising amplitude exists.

The increase in the snaking motion indicates that the driver is unable to stabilize the vehicle-trailer combination on his/her own.

An advantageous embodiment of the present invention is characterized in that, in the event of a detected panic steering response by the driver, a lower intensity limiting value is selected than in the event of a driving maneuver detected as being carried out deliberately by the driver. This ensures that, in the event of a panicky behavior of the driver, a rapid stabilizing intervention takes place.

An advantageous embodiment of the present invention is characterized in that a low-pass filter is provided which filters the parameter prior to further processing, thereby filtering out high-frequency interference.

An advantageous embodiment of the present invention is characterized in that
a steering angle analysis takes place only when at least the change in the steering angle per time unit exceeds a predefined limiting value, and
the intensity limiting value is set to a predefined standard value in case no steering angle analysis takes place.

The steering angle analysis takes up computing time in the control unit (for example in the control unit of the vehicle dynamics controller). It is therefore advantageous to execute the steering angle analysis only when there are indications of a significant steering response by the driver.

An advantageous embodiment of the present invention is characterized in that a steering angle analysis takes place only when the intensity of the snaking motion additionally exceeds a predefinable limiting value. Unnecessary steering angle analyses are avoided due to this fact.

An advantageous embodiment of the present invention is characterized in that the intensity of the snaking motion is determined on the basis of the difference between the low-pass filtered actual yaw rate of the road vehicle and the setpoint yaw rate.

An advantageous embodiment of the present invention is characterized in that the setpoint yaw rate is determined on the basis of a one-track model. This is mathematically simple and, from the programming standpoint, also easy to implement.

The present invention includes a method for damping the snaking motion of a trailer towed by a road vehicle in which
a trailer's snaking motion and this motion's intensity are detected based on a variable into which there enters at least one variable describing the transverse vehicle dynamics, and
when an intensity limiting value is exceeded due to the intensity of the snaking motion, damping of the snaking motion takes place on the basis of driver-independent braking interventions in the road vehicle and/or a driver-dependent throttling of the engine torque;
   characterized in that
at least one parameter is determined from the shape of the curve over time of the steering angle, and
the intensity limiting value, in response to whose exceeding by the intensity of the snaking motion, the snaking motion is damped, is a function of the parameter determined.

It goes without saying that the advantageous embodiments of the device according to the present invention also manifest themselves as advantageous embodiments of the method according to the present invention and vice versa.

As a result of crosswind, for example, snaking motions may occur in a vehicle-trailer combination in which the trailer oscillates about its vertical axis, thereby also inciting the towing vehicle to oscillate via the trailer hitch. If vehicle speed vFz is below critical speed vFzcrit (vFz<vFzcrit), then the oscillations are damped, at vFz=vFzcrit they are undamped, and above the critical speed (vFz>vFzcrit) amplitude and intensity of the oscillations increase.

Among other things, the value of critical speed vFzcrit depends on geometrical data such as the wheelbase, the draw bar length, the mass moment of inertia and the yaw moment of inertia of the vehicle and the trailer, and on the skew stiffness of the axles. In passenger car combinations, this value of the critical speed is typically in the range between 90 km/h and 130 km/h. The difference between the preprocessed (particularly low-pass filtered) yaw rate vGiF and the setpoint yaw rate vGiSoAck, formed from the driver input (steering angle, vehicle longitudinal velocity), is used for identifying the vehicle-trailer combination's snaking motion. In addition, the steering angle is taken into account when stabilizing interventions are enabled in order not to intervene too sensitively during deliberate steering motions by the driver. Therefore, the steering motions by the driver are analyzed to enable vehicle-trailer combination stabilization at an early stage in the event of a panic steering response, thereby contributing to increased safety. Based on the steering motions by the driver and variables derived therefrom, the driver's intent is analyzed and evaluated. The stabilizing interventions are enabled as a function thereof. This makes it possible to detect a panic response by the driver in a timely manner, to enable necessary stabilizing interventions according to the situation, and to adapt triggering of oscillation-damping interventions to particular driving maneuvers as efficiently as possible. The method thus contributes to increased safety and comfort when driving with a trailer in tow.

The analysis of the steering angle motions is explained on the basis of FIG. 2.

The steering motions by the driver are analyzed in block 201 with regard to:
the steering angle Lw,
the steering angle change (per time unit), as well as
the duration of the steering motions.
   A parameter KoLw is formed from this analysis. This parameter is filtered in block 202 using a low-pass filter, from which filtered parameter KoLwF is subsequently obtained.

Different driving situations are recognized in blocks 203 and 204 based on filtered parameter KoLwF and optionally additional parameters. Solely two blocks (203 and 204) are plotted as an example in FIG. 2; of course, only one block or more than two blocks may also be used as is indicated by the points (, , . . . ”) in the vertical direction between blocks 203 and 204.

A panic steering motion or steering response by the driver is detected in block 203 based on parameter KoLwF. Damping of the trailer vibration via driver-independent braking interventions is vital in this case. A panic steering response by the driver is detected in that parameter KoLwF exceeds a threshold value (which is optionally dependent on the vehicle longitudinal velocity). In addition to the value being exceeded, further conditions such as, for example, a yaw rate threshold value or increasing amplitudes of the trailer oscillation, may be used.

In addition to determining a panic situation, other driving situations, such as, for example, passing another motorist while having a slightly snaking trailer, may be detected from the analysis of the steering angle curve and, based on this information, the triggering threshold value and thus intervention enabling may be adapted to prevent unnecessary interventions.

A passing maneuver is detected in block 204. For example, the vehicle veers to the left on a multilane roadway and subsequently back to the right. Driver-independent braking interventions are undesirable in this case (as long as the intensity of the trailer oscillation does not naturally exceed a predefinable threshold value).

In another block (not shown) it may be detected, for example, that, in an expert manner, the driver already automatically counter-steers the trailer vibrations via skillful steering maneuvers. Driver-independent braking interventions are also omitted in this case.

The output signals of blocks 203 and 204 (and optionally of additional blocks) are supplied to block 205 in which the driver-independent interventions into the brake system (wheel-individual braking interventions) and/or into the engine controller (throttling of the engine torque) are carried out.

For recognizing the particular situation, blocks 203 and 204 are naturally provided with further parameters (e.g., vehicle longitudinal velocity vFz or low-pass filtered yaw rate vGiF) in addition to parameter KoLwF.

The steering angle curve is analyzed in block 201 only when the analysis is enabled via input 206 of block 201. The steering angle gradient may be taken into account for this purpose, for example. In order to avoid premature termination of the panic detection during leveling out of the steering angle curve, a limiting value (and possibly other conditions such as a second yaw rate threshold value), which is different from the triggering threshold value, is used for aborting the steering angle analysis and resetting the panic detection.

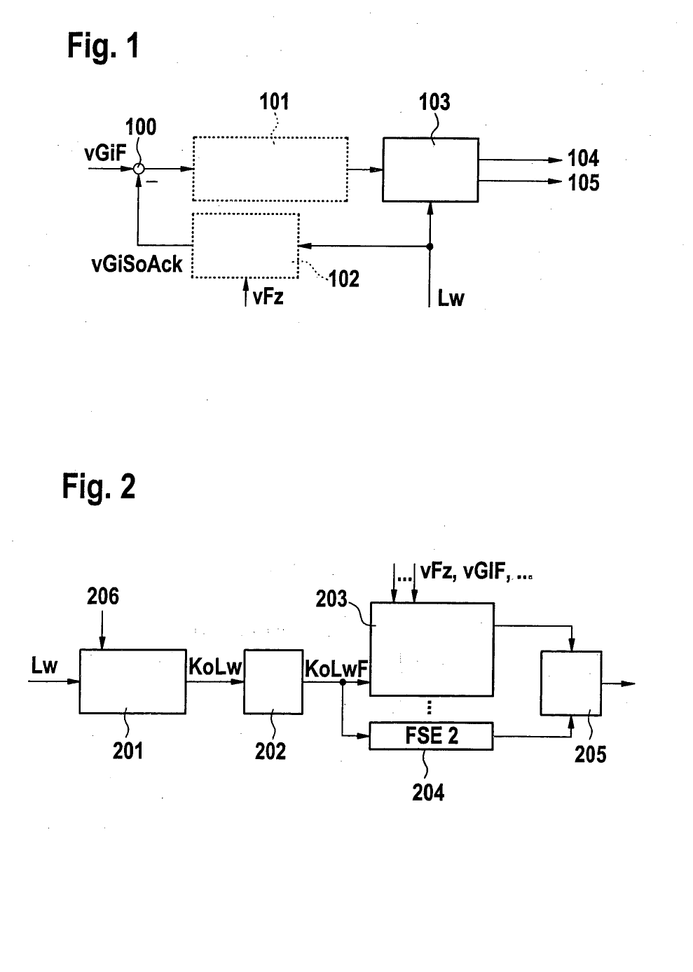

The integration of the device illustrated in FIG. 2 into a larger system is illustrated in FIG. 1. Block 103 represents the system illustrated in FIG. 2.

The differential between actual yaw rate vGiF and setpoint yaw rate vGiSoAck is formed in block 100 in FIG. 1. Setpoint yaw rate vGiSoAck is formed in block 102 from input variables Lw (=steering angle or steering wheel angle) and vFz (=vehicle longitudinal velocity). Based on the shape of the curve of variable vGiF-vGiSoAck over time it is determined in block 101 whether a snaking motion of the trailer (which incites a rolling motion of the vehicle) is present. Differential variable vGiF-vGiSoAck is checked for periodically or almost periodically recurring structures. What is known as wavelet transform is suitable for this purpose. As an alternative to a wavelet transform, the use of a Fourier transform is also conceivable in principle; in programming terms, however, its implementation has the disadvantage that it requires much more memory space (very high data compression rates are achievable in a wavelet transform).

The output signal from block 101 is supplied to block 103. There, based on the steering angle (and optionally on further additional signals), the decision is made about enabling driver-independent measures for stabilizing the vehicle-trailer combination. In particular, throttling of the engine torque (output 104) or wheel-individual braking interventions (output 105) are conceivable.

1. A device for damping the snaking motions of a trailer towed by a road vehicle, comprising:
snaking motion detection means (101) by which the trailer's snaking motion and the motions's intensity are detected based on a variable (vGiF-vGiSoAck) into which there enters at least one variable (vGiF) describing the transverse vehicle dynamics,
snaking damping means which, when an intensity limiting value is exceeded by the intensity of the snaking motion, damp the snaking motion on the basis of driver-independent braking interventions (105) in the road vehicle or a driver-independent throttling of the engine torque (104), and
steering angle analyzing means (201) which determine at least one parameter (KoLw) from the shape of the curve of the steering angle (Lw) over time, and wherein
the intensity limiting value, in response to whose exceeding by the intensity of the snaking motion, the snaking motion is damped, is a function of the parameter (KoLw) determined.

2. The device according to claim 1, wherein the steering angle analyzing means (201) are designed in such a way that, at least based on the parameter (KoLw) determined thereby, a distinction is made between
a panic steering response by the driver, and
a driving maneuver deliberately carried out by the driver, and wherein
the intensity limiting value is a function of whether a panic steering response by the driver or a driving maneuver carried out deliberately by the driver is present.

3. The device according to claim 2, wherein a panic steering response by the driver is detected to be present when the parameter (KoLw) determined exceeds a parameter threshold value.

4. The device according to claim 3, wherein the parameter threshold value is a function of the vehicle longitudinal velocity (vFz).

5. The device according to claim 2, wherein a panic steering response by the driver is only determined when the intensity of the snaking motion additionally increases over time.

6. The device according to claim 2, wherein, in the event of a detected panic steering response by the driver, a lower intensity limiting value is selected than in the event of a driving maneuver detected as being carried out deliberately by the driver.

7. The device according to claim 1, wherein
a low-pass filter is provided through which the parameter (KoLw) is filtered prior to its further processing.

8. The device according to claim 1, wherein
a steering angle analysis takes place only when at least the change of the steering angle per time unit exceeds a predefined limiting value, and
the intensity limiting value is set to a predefined standard value in case no steering angle analysis takes place.

9. The device according to claim 8, wherein
a steering angle analysis takes place only when the intensity of the snaking motion additionally exceeds a predefinable limiting value.

10. The device according to claim 1, wherein the intensity of the snaking motion is determined on the basis of the differential between the road vehicle's low-pass filtered actual yaw rate (vGiF) and the setpoint yaw rate (vGiSoAck).

11. The device according to claim 8, wherein the setpoint yaw rate (vGiSoAck) is determined on the basis of a one-track model.

12. A method for damping the snaking motion of a trailer towed by a road vehicle, comprising
detecting a trailer's snaking motion and the motion's intensity based on a variable (vGiF-vGiSoAck) into which there enters at least one variable (vGiF-vGiSoAck) describing the transverse vehicle dynamics, and
when an intensity limiting value is exceeded by the intensity of the snaking motion, damping the snaking motion on the basis of driver-independent braking interventions (105) in the road vehicle or a driver-independent throttling of the engine torque (104), wherein
at least one parameter (KoLw) is determined from the shape of the curve of the steering angle (Lw) over time, and
the intensity limiting value, in response to whose exceeding by the intensity of the snaking motion, the snaking motion is damped, is a function of the parameter (KoLw) determined.
